(19) United States
(12) Patent Application Publication
(10) Pub. No.: US 2012/0286053 A1
(43) Pub. Date: Nov. 15, 2012

(54) Heat exchanger for a mobile heating device, and motor vehicle

(75) Inventors: Gunter Galtz, Strasslach-Dingharting (DE); Tobias Hentrich, Munchen (DE); Stephan Polzin, Seefeld Hechendorf (DE)

(73) Assignee: WEBASTO AG, Stockdorf (DE)

(21) Appl. No.: 13/511,489

(22) PCT Filed: Nov. 23, 2010
(86) PCT No.: PCT/DE10/01368

§ 371 Date: Aug. 1, 2012

(30) Foreign Application Priority Data
Nov. 25, 2009 (DE) 10 2009 055 686.9

(51) Int. Cl. B60H 1/22; F23M 5/00

(52) U.S. Cl. 237/33; 165/41; 431/114

(57) ABSTRACT

The invention relates to a heat exchanger for a mobile heating device comprising a burner, the heat exchanger having a carrier body with an inner face and an outer face. The inner face of the carrier body is formed as an inner exhaust gas duct for conducting exhaust gas of the burner. Furthermore, a channeling is arranged between the inner face and the outer face of the carrier body for conducting a heat transfer medium. The heat transfer medium is in heat conducting contact, via the inner face, with exhaust gas in the inner exhaust gas duct. At the outer face of the carrier body, an outer exhaust gas duct for conducting exhaust gas of the burner is provided. The heat transfer medium is in heat conducting contact via the outer face of the carrier body with exhaust gas flowing in the outer exhaust gas duct. The present invention further relates to a mobile heating device having a burner and to such a heat exchanger and to a motor vehicle comprising such a heating device.

The invention relates to a heater exchanger for a mobile heating device having a burner. The invention further relates to a mobile heating device having a burner and a heat exchanger and to a motor vehicle having a heating device.

Mobile heating devices are used as supplementary heating devices in vehicles to heat a heat transfer medium such as air or water. Known fields of application include heating of a passenger compartment or preheating cooling water of a combustion motor of a vehicle.

In the case of a burner of a mobile heating device of this type, usually a liquid fuel, drawn, for instance, from a fuel tank of a vehicle, is mixed with air and ignited. Hot exhaust gases generated by the combustion are guided through a heat exchanger and heat a heat transfer medium which is channeled in a channeling of the heat transfer medium surrounding the hot exhaust gas. Water or an aqueous mixture is often used to provide the liquid heat transfer medium, for instance, a mixture of 50% water and 50% glycol.

For example, such a heating device having a cup-shaped heat exchanger and a substantially tubular barrier extending in a step-wise manner to a burner is described in patent document DE 102 03 116 B4. Exhaust gas flows through an inner space of the tubular barrier, the inner space being heated by a heat transfer medium flowing past an outer face of the tubular barrier.

In conventional heat exchangers, a large portion of the thermal energy of the exhaust of the burner, which is also referred to as smoke gas, is transferred to the heat transfer medium so that a degree of efficiency of up to 80 to 85% may result. However, the exhaust gas exiting the heat exchanger after delivering its energy often still has a relatively high speed which may result in undesired noise. Therefore, a noise suppressor arrangement is usually provided next to such a heat exchanger, which may require a non-negligible amount of space.

It is an object of the invention to increase the degree of efficiency of a heat exchanger and to allow for a more compact design.

This object is achieved by the features of the independent claims.

Further advantageous embodiments and further designs of the invention are described in the dependent claims.

A heat exchanger for a mobile heating device having a burner is proposed. The heat exchanger has a carrier body having an inner face and an outer face, the inner face being formed as an inner exhaust gas duct for channeling exhaust from the burner, and further comprises a channeling arranged between the inner face and the outer face of the carrier body and which is arranged to channel a heat transfer medium, the heat transfer medium being in heat conducting contact via the inner face of the carrier body with the exhaust gas flowing in the inner exhaust gas duct, wherein an outer exhaust gas duct for conducting exhaust gas to the burner is provided on the outer face of the carrier body, the heat transfer medium being in heat conducting contact via the outer face of the carrier body with the exhaust gas flowing in the outer exhaust gas duct. The heat transfer medium is thus envisioned to be in heat conducting contact with exhaust gas not only via one face but via both the inner face and the outer face. This results in a significantly larger heat transfer area, whereby the thermal energy of the exhaust gas may be transferred to the heat transfer medium even more efficiently. A thermal degree of efficiency of, for example, more than 90% can thus be achieved. Thus, a higher heating power with the same energy costs or a desired heating power with lower energy costs is achieved. Further possibilities for saving energy may also result. For instance, blower power for feeding combustion air to the burner may be reduced, whereby electrical energy is saved. Thus, acoustic emissions may also be reduced. Furthermore, exhaust gas may be cooled further, as compared to the prior art, facilitating conduction of the exhaust gas. Notably, new and more cost efficient materials which are too sensitive for higher exhaust gas temperatures can be used for the exhaust gas duct. A complicated exhaust gas duct may possibly be dispensed with altogether. The lower exhaust gas temperature and, as a consequence thereof, lower flow speed of the exhaust gas at the point of exiting the heat exchanger also contributes to a reduction of the noise generated by the exhaust gas. Therefore, installation of a noise suppressor can possibly be dispensed with, leading to a more compact design. Normally, the inner face and the outer face of the carrier body are formed significantly larger, in regard to surface, than side faces which may additionally be present. It may be envisioned that the inner face is the face of the carrier body which faces the burner of the heating device. It is particularly useful if the exhaust flow from the burner flows partially or completely into the inner face. The outer face may, in this case, be oriented toward an outer environment of the carrier body, in which, for instance, further components arranged in a vehicle may be located. A flow space for the heat transfer medium may be provided between an inner face and an outer face of the carrier body. It may be beneficial to provide guide elements such as fins, for example, in this flow space, for guiding the heat transfer medium to enable a well-defined flow of the heat transfer medium. Furthermore, heat exchange fins for enlarging the heat exchange surface on the inner face may be oriented towards the exhaust gas flow and/or be provided on the inner face and directed towards the flow of the heat transfer medium. It is also possible to additionally or alternatively arrange such heat exchange fins at the outer face and oriented to the exhaust gas flow and/or at the outer face and oriented towards the flow of the heat transfer medium. Heat exchange fins contacting the exhaust gas flow or the flow of the heat transfer medium may also serve to guide the respective flow in addition to their heat exchange function. The carrier body may be formed either as a single piece or as several pieces. It is particularly useful to form the carrier body so as to be substantially cylindrical or tubular. An end of the carrier body may be closed by a floor. Such a floor may be produced particularly easily in a single piece with a tubular part of the carrier body and results in a gastight termination of the inner face of the carrier body at its end. At one orifice at the other end of the carrier body, a burner may be provided, for example, as a seal to which combustion air and fuel are supplied via one or more ducts. Both gaseous and liquid mediums may be used as the heat transfer medium or heat carrier, for instance, air or water. A particularly well-suited heat transfer medium is a mixture of glycol and water. Conveniently, the carrier body has at least one inlet for the heat transfer medium and one outlet for the heat transfer medium. The carrier body may have a heat carrier longitudinal direction which may extend in the direction of its maximum longitudinal dimension. A principle extending direction of the heat exchanger may extend parallel to the carrier body longitudinal direction. The principle extending direction may extend parallel to a longitudinal direction of a flame tube of a burner; in this case, the principle extending direction and the carrier body longitudinal direction may be the same, but this is not necessarily so. Barrier faces which run transversely to the principle extending direction may be considered floor surfaces of the heat exchanger. An outer face running transversely to the principle extending direction or an outer barrier face of the outer exhaust gas duct may act as a floor surface of the outer exhaust gas duct and/or of the heat exchanger. Barrier faces of the carrier body which extend transversely to the carrier body longitudinal direction may be referred to as floor surfaces of the carrier body.

In an embodiment, the heat exchanger may be envisioned to comprise an exhaust gas pipe connecting the inner exhaust duct and the outer exhaust gas duct. Exhaust gas may thus be channeled from the inner face to the outer face or vice versa. The exhaust gas pipe may be formed as a curved tube link. The exhaust gas pipe may be envisioned to comprise or consist of two shells connected to each other. The shells may be connected to each other in a gastight manner. Each shell may have one or more connection flanges. The shells may be envisioned to be interconnected in a gastight manner via the connection flanges. One or more guide bars may be formed within the exhaust gas pipe. It may notably be envisioned that a guide bar extends substantially centrally through the exhaust gas pipe. The guide bar may serve as a flow divider and may notably reduce or prevent undesired vortexes or detachment of vortexes in the exhaust gas pipe. The exhaust gas pipe may have two or more curvatures. The exhaust gas pipe may notably be envisioned to have essentially a U form. The exhaust gas pipe may be formed to redirect an exhaust gas current flowing into it in one direction into a substantially opposite direction. The exhaust gas pipe may be envisioned to be arranged entirely or at least partially outside of the heat carrier body and/or the outer exhaust gas duct. A distance space may be arranged between a barrier of the exhaust gas pipe facing the outer exhaust gas duct, or a jacket of the outer exhaust gas duct, and/or facing the heat carrier body. The distance space may be freely accessible towards the outside. An outlet of the inner exhaust gas duct may be provided, via which exhaust gas may flow from the inner side of the carrier body to the outer exhaust gas duct. Conveniently, the outer exhaust gas duct has at least one exhaust gas inlet via which exhaust gas may enter the outer exhaust gas duct from the inner exhaust gas duct and/or from the exhaust gas pipe. The outer exhaust gas duct may have at least one exhaust gas outlet via which exhaust gas may flow from the outer exhaust gas duct. In this case, exhaust gas may be purged via a tube, for example. The tube may be a plastic tube. It may be envisioned that a burner is arranged at or attached to the heat exchanger. The burner may have a flame pipe. The flame pipe may be included entirely or at least partially on the inner face of the heat exchanger. It may notably be envisioned that the flame pipe is at least partially included in an inner region of the carrier body. An inner exhaust gas flow space for conducting exhaust gas may be formed between the flame pipe and the carrier body or the inner face of the carrier body. The inner exhaust gas duct may notably be at least partially formed by a cladding of the flame pipe and a cladding of the carrier body facing the cladding of the flame pipe.

It may notably be envisioned that the heat exchanger is arranged such that exhaust gas flows through the inner exhaust gas duct before flowing through the outer exhaust gas duct. This is particularly beneficial if the burner is arranged in the interior of the carrier body or arranged such that the exhaust gas first flows into the inner face before it flows to the outer face. Exhaust gas flowing on the outer face has thus already been cooled by a precedent heat conducting contact with heat transfer medium inside the carrier body, and the heat strain on components arranged outside of the heat carrier, such as vehicle components, is kept low. Further, the outer exhaust gas duct may have one or more exhaust gas inlets and one or more exhaust gas outlets.

In a particularly beneficial variant, a noise suppressor or a noise suppressor device is provided in the outer exhaust gas duct. A noise nuisance caused by the heat exchanger may thus be reduced without requiring an additional external noise suppressor device. As the exhaust gas in the outer exhaust gas duct may already be cooled to a great extent due to the improved energy transfer from the exhaust gas to the heat transfer medium, the noise suppressor device may be formed relatively small. A system is provided, which, when taken as a whole, is more compact. The noise suppressor device may comprise a noise absorbing or noise suppressing material. The noise suppressing material may be arranged directly in the outer exhaust gas duct. It may notably be envisioned that the noise suppressing material is arranged at a part of a cladding of the outer exhaust gas duct. The noise suppressor device or the noise suppressing material may be provided at a floor surface of the heat exchanger, for example, at a floor surface of the outer exhaust gas duct. A holding means, such as a perforated grid, may be provided to hold the noise suppressing material in the outer exhaust gas duct. A noise absorbing material can be arranged so that it contacts or is put into contact with exhaust gas flowing through the outer exhaust gas duct during operation. Conveniently, the noise suppressor device may be arranged in a region of the outer exhaust gas duct in which exhaust gas flows around the carrier body. In this case, it may be envisioned that an exhaust gas current flows past the noise suppressor device on the one side and on a side at the carrier body which is opposite relative to the exhaust gas flow. It may notably be envisioned that the noise suppressor comprises stone wool and/or glass fiber wool as a noise suppressing material. This offers a simple and cost-efficient way of arranging a noise suppressor in the outer exhaust gas duct. Furthermore, the noise suppressor may comprise, additionally or alternatively to stone wool or another noise suppressing material, one or more lamda/4 resonance paths or Kundt's tubes. The one or more Kundt's tubes are, in this case, conveniently set to one or more frequencies generated when the heat exchanger or the heater is operated. Noise suppression may thus be achieved in a simple and efficient manner.

Conveniently, guide fins for guiding the exhaust gas are provided in the outer exhaust duct. The exhaust gas flow may easily be guided or channeled by such guide fins. It may be envisioned that the guide fins define a preferred flow direction or a desired flow field between an inlet of the outer exhaust gas duct and an outlet of the outer exhaust gas duct. Individual guide fins may be straight or have a curvature in a direction in which they guide a flow and/or in their longitudinal direction. It may be envisioned that several guide fins extend parallel to each other. In an arrangement of several guide fins, it may be envisioned that at least some of them do not extend parallel to each other in the direction in which they guide a flow and/or in their longitudinal direction. The guide fins may be provided at the carrier body. The guide fins may notably be formed at the carrier body or be attached to it. In a particularly preferred variant, the heat exchanger body is made of a cast material. The guide fins may then be formed directly in casting the carrier body. Guide fins formed at the carrier body may also serve to transfer heat onto the heat transfer medium. It may be envisioned that an exhaust gas inlet and an exhaust gas outlet of the outer exhaust duct are arranged adjacent to each other in a circumferential direction. The outer exhaust gas duct may, in this case, be formed such that an exhaust gas flow results which runs at least around a large portion of the circumference of the carrier body to pass from the inlet to the outlet. Additionally, guide fins and/or flow obstacles may be provided, for example, to prevent exhaust gas from flowing directly from the inlet to the outlet. A labyrinth for guiding the exhaust gas may be provided in the outer exhaust gas duct. A desired heat exchange between the heat transfer medium and the exhaust gas may thus be achieved. Notably, guide fins may be provided to form the labyrinth.

It is a particularly beneficial if the outer exhaust gas duct comprises a jacket of the carrier body which may notably be a jacket of an outer barrier of the carrier body. It is particularly advantageous if an exhaust gas flow space is provided between the jacket of the carrier body and the carrier body. Guide fins or a labyrinth may, for example, be arranged in the exhaust gas flow space. It may be envisioned that the outer exhaust gas duct or the jacket surrounds the carrier body radially or in the longitudinal direction. For instance, space may thus be provided for additional components, such as temperature sensors for measuring the temperature of the heat transfer medium. However, it may also be envisioned that the outer exhaust gas duct or its jacket surrounds the carrier body radially or in the longitudinal direction essentially in full. A maximum degree of efficiency may thus be achieved. The jacket may be made of a heat insulating material to prevent the exhaust gas heat from moving to the outside. The jacket may be formed in several pieces. It may be envisioned that a portion of the jacket is formed as a cap which is slid at least partially over the carrier body. It may be envisioned that the cap is arranged such that it surrounds the carrier body fully or at least partially in the carrier body longitudinal direction and/or with respect to a circumference surrounding the principle extending direction or the carrier body longitude direction. A cap of the jacket may be connected to a further jacket part, such as a coat, in a gastight manner. The cap or the jacket may be attached to the carrier body. For instance, it may be envisioned that the cap and/or the jacket are screwed to the carrier body by means of screws, for instance, self-cutting screws. A distance may be set between the jacket, and/or the cap of the jacket, and guide fins which may be present in the outer exhaust gas duct. A noise suppressor may be provided in a cap of the jacket. The noise suppressor may notably comprise a noise absorbing or noise suppressing material. The noise absorbing or noise suppressing material may, for instance, be held in the cap by a perforated grid. Conveniently, the noise absorbing material is arranged at a cap floor of the jacket. An exhaust gas flow may be guided from an inlet to an outlet of the outer exhaust gas duct such that, in doing so, it flows past the cap floor or past the noise absorbing material. The jacket and/or a cap of the jacket may have guide fins protruding into the exhaust gas flow space of the outer exhaust gas duct. Such guide fins may be provided as an alternative or additionally to guide fins arranged at the carrier body.

Furthermore, an exhaust gas divider arranged to distribute an exhaust gas flow from the burner on at least two separate partial flows may be provided. The exhaust gas divider is further arranged to feed at least one partial flow to the inner exhaust gas duct and one partial flow to the outer exhaust gas duct, respectively. It may thus be achieved that the heat transfer medium conducted in the channeling of the heat transfer medium is heated from both sides by exhaust gas having the same temperature, resulting in more uniform heating and more uniform flow of the heat transfer medium.

Furthermore, a mobile heating device having a burner and a heat exchanger as described above is proposed. Such a heating device is suitable as a supplementary heating device, park heating, or auxiliary heating for a vehicle. It is particularly advantageous if the burner is arranged within the inner exhaust gas duct, or such that exhaust gases may come into heat conducting contact with a heat transfer medium or with an inner barrier of the carrier body directly after leaving the burner on an inner face of the carrier body. The heating device may have an exhaust blower for supporting the flow of the exhaust gases. The exhaust gas blower may notably be provided downstream of an exhaust gas outlet of the outer exhaust gas duct and be arranged to draw exhaust gas.

Furthermore, a motor vehicle having a mobile heating device of this type is proposed.

The invention will now be explained by way of example in reference to the accompanying figures on the basis of preferred embodiments.

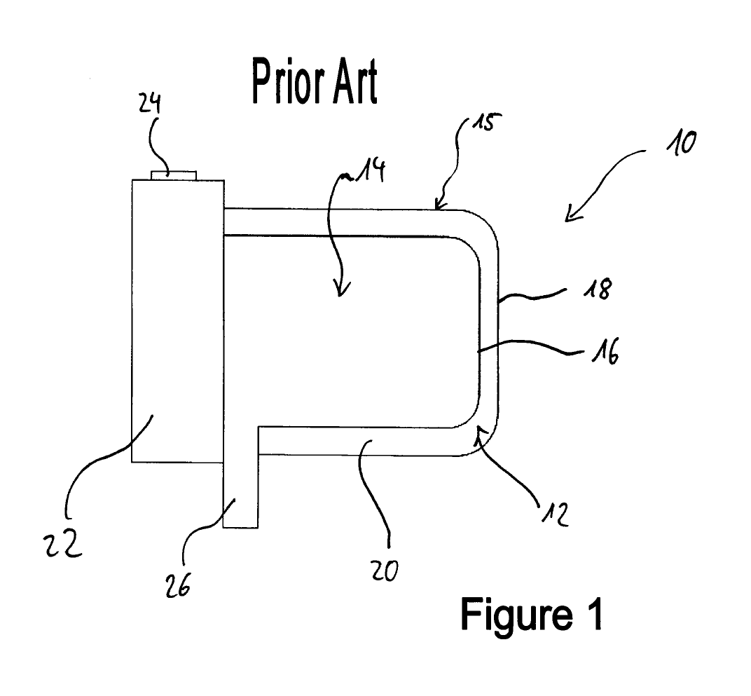

FIG. 1 schematically shows an example of a heat exchanger according to the prior art in a sectional view;

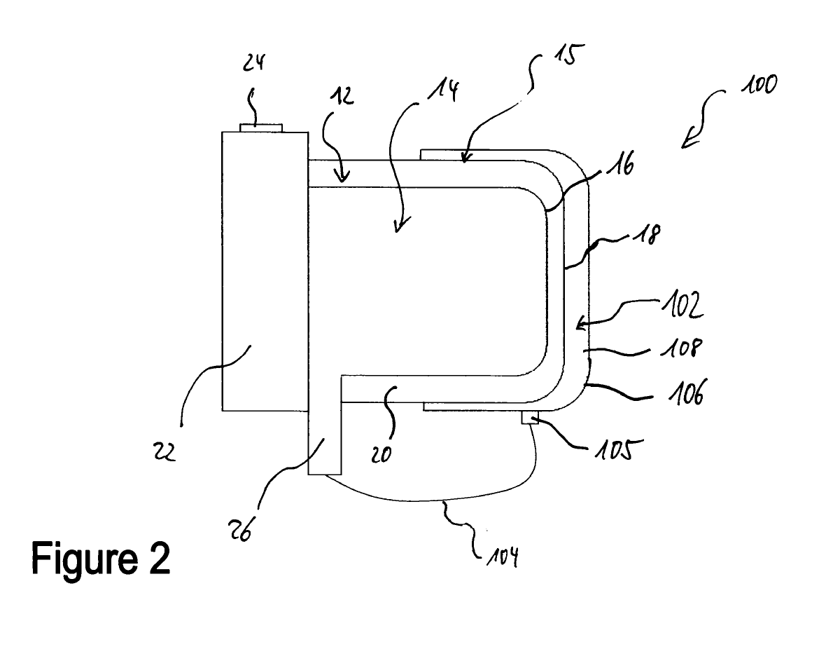

FIG. 2 shows a schematic representation of a heat exchanger having an outer exhaust gas duct, in a sectional view;

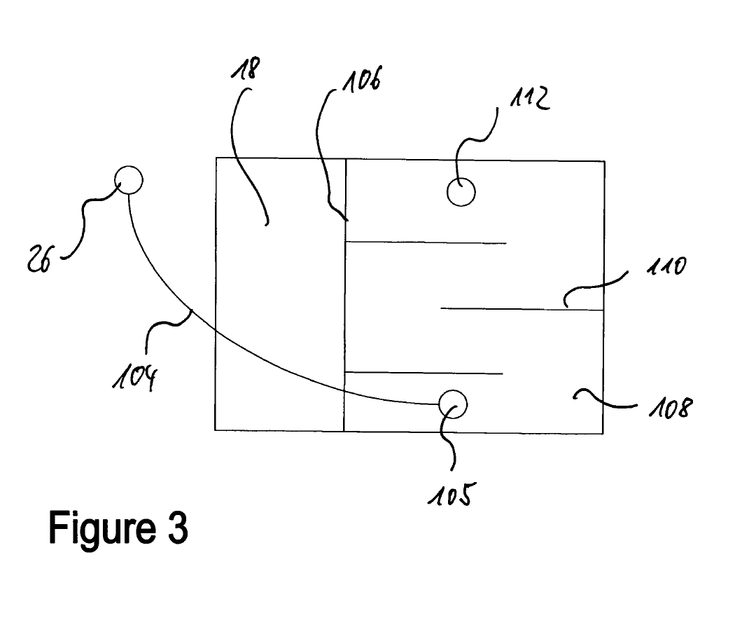

FIG. 3 shows a further schematic representation of a heat exchanger having an outer exhaust gas duct in a view from below;

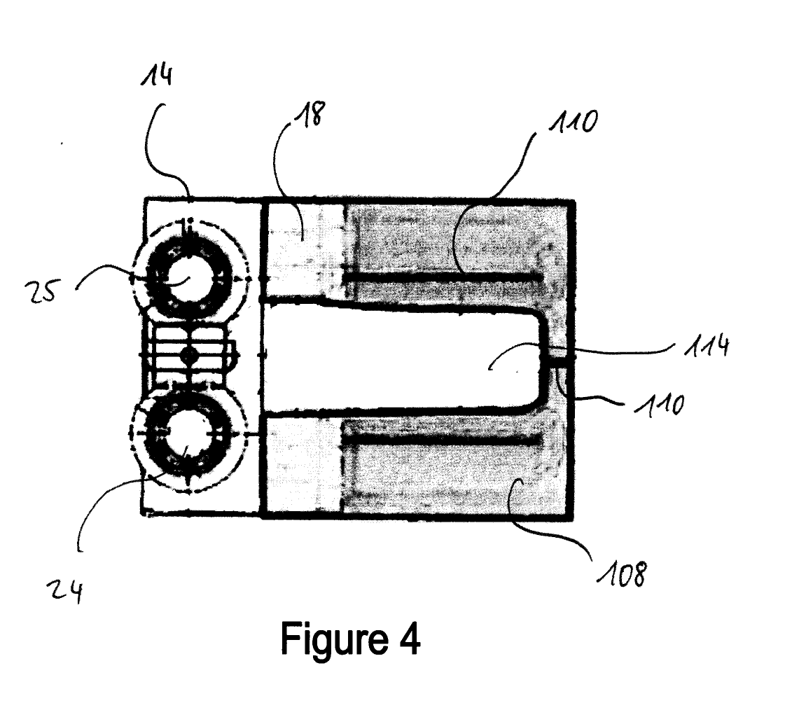

FIG. 4 shows a further schematic representation of a heat exchanger having an outer exhaust gas duct in a top view;

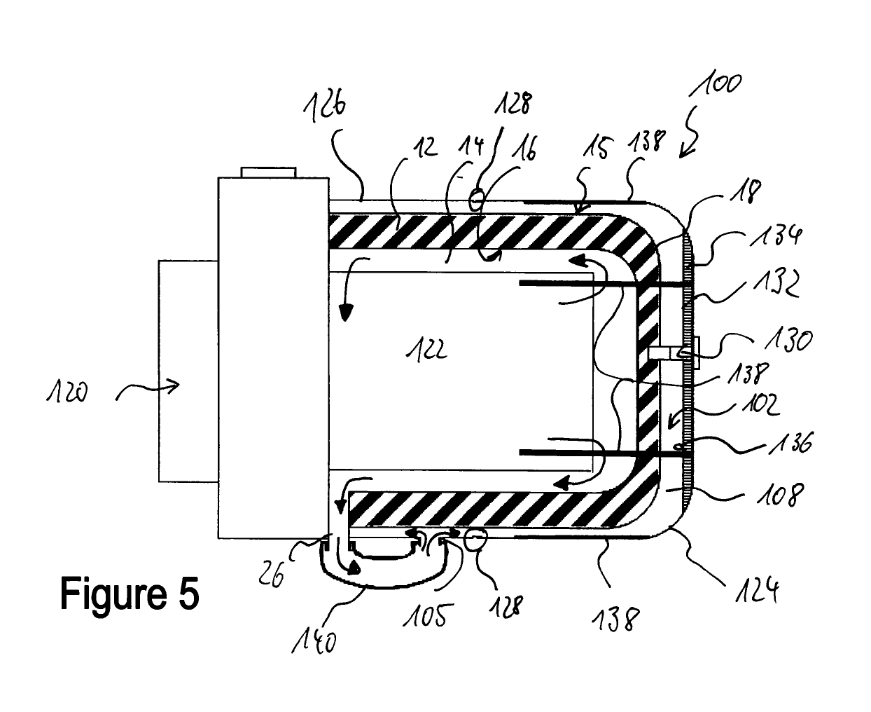

FIG. 5 shows a further schematic representation of a heat exchanger in a sectional view, in which a burner having a flame pipe can be seen;

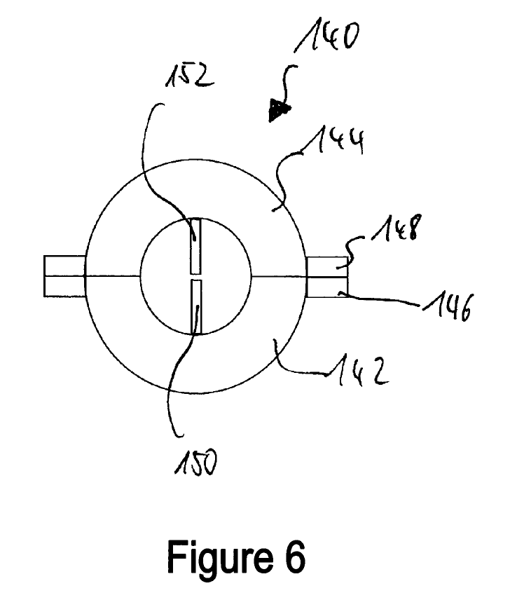

FIG. 6 shows a cross sectional view of an exhaust gas duct; and

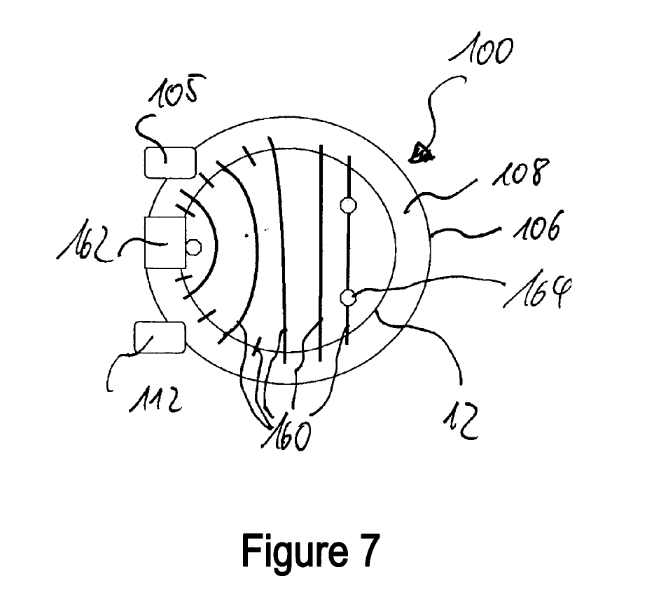

FIG. 7 shows a cross-sectional view of a heat exchanger, in which guide fins arranged at the carrier body can be seen.

FIG. 1 schematically shows an example of a heat exchanger 10 according to the prior art. The heat exchanger 10 comprises a carrier body 12 that is cup shaped and has an inner face 14 and an outer face 15. The carrier body 12 further comprises an inner barrier 16 on its inside and an outer barrier 18 surrounding the inner barrier 16 on its outer side. A flow space 20 for a heat transfer medium is formed between the inner barrier 16 and the outer barrier 18. A carrier ring 22 is attached to the carrier body 12 in a manner known in the art. The carrier ring 22 has an inlet 24 for the heat transfer medium and an outlet (not shown) for the heat transfer medium and enables an inflow and an outflow of the heat transfer medium into the flow space 20. A seal may be provided at the carrier ring 22 to seal the carrier body 12 in a gastight manner. The inner barrier 16 and the outer barrier 18 are formed of a heat conductive material, such as an aluminum or steel alloy. Fins (not shown) are provided at the inner barrier 16 on the inner face 14 for improving the heat transfer and for guiding an exhaust gas flow. The exhaust gas flow originates here from a burner (not shown) arranged within the space formed on the inside and is fed by the burner into this space formed on the inner face 14 of the carrier body 12. On the inner face 14, the exhaust gas flow is surrounded by the inner barrier 16, and the inner face 14 is thus formed as an inner exhaust gas duct. Furthermore, an exhaust gas outlet 26 is provided, through which exhaust gas from the inner face 14 of the heat exchanger 10 is discharged after having transferred a major portion of its heat content to the heat transfer medium via the inner barrier 16. In this example, a mixture of 50% water and 50% glycol is used as the heat transfer medium. The heated heat transfer medium may be supplied to an outer heating circuit (not shown) via the outlet for the heat transfer medium and may recirculate into the flow space 20 via the inlet for the heat transfer medium 24 and be reheated.

FIG. 2 schematically shows a view of a further heat exchanger 100 corresponding to the view in FIG. 1. The heat exchanger 100 differs from the heat exchanger 10 shown in FIG. 1 essentially in the presence of an outer exhaust gas duct 102 on the outer face 15. To simplify, like reference symbols will be used in the following for identical or similar features. The outer exhaust gas duct 102 has an exhaust gas inlet 105 connected to the exhaust gas outlet 26 via a schematically represented exhaust gas pipe 104 so that exhaust gas from the exhaust gas duct on the inner face 14 may flow into the outer exhaust gas duct 102 via the exhaust gas outlet 26, the exhaust gas pipe 104, and the exhaust gas inlet 105. The outer exhaust gas duct 102 comprises a jacket 106 which is arranged such that an exhaust gas flow space 108 is formed between the outer barrier 18 and the jacket 106. In this example, exhaust gas flows on the inner face 14 in heat conducting contact with the inner barrier 16 and releases heat to the heat transfer medium in the flow space 20. The exhaust gas which has already cooled is then guided to the outer exhaust gas duct 102 and flows around the flow space 20 from the outside. At the same time, the exhaust gas is in heat conducting contact with the heat transfer medium in the flow space 20 via the outer barrier 18 which is made of a heat conductive material and may, for instance, have guide fins (not shown) or heat exchange fins, and continues to release heat to the heat transfer medium. The jacket 106 does not extend completely around the carrier body 12 in the longitudinal direction. For example, sensors for monitoring the temperature of the heat transfer medium or combustion air feeds or fuel feeds may thus be arranged at the carrier body without need to pass ducts through the jacket 106. However, in this example, the jacket 106 completely surrounds the carrier body 16 radially to ensure a maximum degree of efficiency.

FIG. 3 schematically shows a view of a heat exchanger 100 from below. In this figure, fins 110 arranged in the exhaust gas flow space 108 can be seen, which channel the exhaust gas flow in the outer exhaust gas duct 102 as desired, in order to achieve a maximum exchange of heat with the heat transfer medium via the outer barrier 18. To this end, the exhaust gas flow is, in this example, guided essentially in parallel successive paths, and respectively, in the opposite direction. Furthermore, an outer exhaust gas outlet 112 is shown via which exhaust gas which has cooled may leave the outer exhaust gas duct. It may be seen that the jacket 106 does not completely cover the outer barrier 18 in the longitudinal direction. An arbitrary number of fins 110 may be provided between the exhaust gas inlet 105 and the outer exhaust gas outlet 112, the number depending on the desired flow conditions. The exhaust gas outlet 106 does not necessarily need to be arranged at the carrier body 12. It may, for instance, be provided in a carrier ring 22 as suggested in FIG. 3 without representing the carrier ring.

A further schematic view of a heat exchanger 100 which may be a heat exchanger 100 as shown in FIG. 3 is shown in FIG. 4 from above. Some additional elements mounted to the carrier body 12 on the outside are represented in this view. Notably, a carrier ring 22 is shown, at which an inlet for the heat transfer medium 24 and an outlet for the heat transfer medium 25 are provided. FIG. 4 further shows an outer region of the outer barrier 18, which is not covered by the jacket 106 or the carrier ring 22 and in which exhaust gas flows only on the inner face 14. Furthermore, a region corresponding to the exhaust gas flow space 108 can be seen. In this region, exhaust gas flows both on the outer face of the carrier body 12, namely in the exhaust gas flow space 108 and on the inner face 14 and while doing so, is in heat conducting contact with the heat transfer medium in the flow space 20 for the heat transfer medium located there between. In this view, the inner face 14 and the flow space 20 can, however, not be seen. A prolongation 114 extends over part of the jacket 106 and part of the outer barrier 18 not surrounded by the jacket 106. The jacket 106 may, alternatively, be arranged such that it does not extend below the prolongation 114 but around it. At the prolongation 114, sensors, contacts for electrical or electronic components or connections from combustion air or fuel for operating a burner may be provided.

FIG. 5 schematically shows a sectional view of a heat exchanger 100 having a burner 120. The burner 120 may be attached to the heat exchanger 100 in a suitable manner, for instance, by a screw connection. The burner 120 has a flame pipe 122 protruding into the inner space of the carrier body 12. In this view, the carrier body 12 or the flow space for the heat transfer medium is marked with a crossbar. The flame pipe 122 may form a circumferential barrier surrounding a flame produced by the burner 120. It may also be envisioned that the flame pipe 122 is provided with holes for improving the flow characteristics. The flame pipe 122 is open at its end protruding into the carrier body 12. During operation, the burner 120 generates a flame within the flame pipe which may possibly protrude slightly beyond the flame pipe 122, depending on a setting. Exhaust gas generated by the burner 120 flows out of the flame pipe 122 and may flow to the outlet 26 between the inner barrier of the carrier body 12 and the outer barrier of the flame pipe 122. In the present FIG. 5, possible flow directions of exhaust gas are indicated by arrows. In this example, an inner exhaust gas duct is thus formed between the flame pipe 122 and the carrier body 12 or an inner barrier 16 of the carrier body 12. It may be envisioned that the burner 120 is arranged or adjusted so that its flame does not directly reach the inner barrier 16 of the carrier body 12. An excessive punctual heating of the carrier body material and the heat transfer medium can thus be avoided. In FIG. 5, it can be seen that the jacket 106 has a cap 124. In this variant, the cap is slid in a gastight manner onto a jacket 126 surrounding the carrier body 12. To this end, the jacket 126 has a clamp reception 128 onto which an inner circumference of the cap 124 is slid. Furthermore, the cap is attached to the carrier body 12 via a screw connection 130. In the screw connection 130, a screw received in a corresponding reception in the carrier body 12 is shown. In the cap 124, a corresponding screw guide is provided. Conveniently, the cap 124 is attached to the carrier body 12 via several, for instance, three, screws which are arranged similarly. In a floor 132 of the cap 124, a noise suppressing material 134 is arranged. The noise suppressing material 134 is held at the floor by an aperture plate 136 so as to prevent abrasion of material by exhaust gas flowing past. Furthermore, cap guiding fins 138 are provided in the cap 124, four of which are indicated. More than four cap guiding fins 138 may be provided. The cap guiding fins are arranged on the inner face of the cap 124 so that they protrude into the exhaust gas flow space 108 of the outer exhaust gas duct. It is beneficial if guide fins projecting into the exhaust gas flow space 108 are also formed at the carrier body 12. The exhaust gas outlet 26 and the exhaust gas inlet 105 are connected by an exhaust gas pipe, which in this example is formed as a tube connection 140. The tube connection 140 extends outside the jacket 106. It has two curvatures which together reverse the flow direction of the exhaust gas flowing out of the outlet 26, so that exhaust gas flows into the exhaust gas inlet 105 of the outer exhaust gas duct in the opposite direction. Preferably, the tube connection 140 is designed so as to obtain a soft flow channeling without edges at which turbulences may form and/or detach. The tube connection 140 is notably formed substantially in a U shape.

FIG. 6 shows a cross sectional view of a tube connection 140 which may, for instance, be used in the arrangement shown in FIG. 6. The tube connection 140 comprises a first tube shell 142 and a second tube shell 144. The first tube shell 142 has first connecting flanges 146, 147, whereas the second tube shell 144 has second connecting flanges 148, 149. The tube shells 142, 144 are interconnected in a gastight manner via the connecting flanges 146, 147. 148, 149, for instance, by screwing, riveting, welding, and/or gluing. In the first tube shell 142, a first guide bar 150 centrally extending within an inner tube radius of the first tube shell 142 is arranged. Conveniently, the guide bar 150 extends from the outlet 26 to the inlet 105. In the second tube shell 144, a second guide bar 152 is provided similarly, the second guide bar 152 being opposite to the first guide bar 150 within the tube connection 140. The guide bars 150, 152 may contact each other in the middle, or be spaced from each other at a certain distance as shown. By using tube shells interconnected in a gastight manner, the tube connection 140 may easily be designed such that it enables a desired flow effect. However, it is also possible to manufacture the tube connection from a circumferential tubular piece or several tubular pieces arranged successively in the flow direction. The tube connection 160 of this example is placed on an outlet nozzle of the outlet 26 and on an inlet nozzle of the inlet 105, respectively, and is maintained by a clamp connection. Other suitable ways of connection may also be envisioned.

FIG. 7 shows a cross-sectional view of a heat exchanger 100 in which guide fins 160 arranged at the carrier body 12 can be seen. The guide fins are formed on the carrier body 12. They are formed to ensure that the exhaust gas flowing through the inlet 105 flows around the carrier body 12 in a desired manner. To this end, a flow field surrounding the carrier body 12 is generated by the guide fins 160. Guide fins 160 may extend straight or at least partially curved in a longitudinal direction and/or in a direction in which they channel an exhaust gas flow so as to generate a desired flow having an appropriate pressure loss. Exhaust gas having flowed around the carrier body 12 may exit the heat exchanger 100 via the exhaust gas outlet 112. The guide fins 160 distribute the exhaust gas in the exhaust gas flow space 108 as desired. Between the inlet 105 and the outlet 112, a flow barrier 162 may be provided to prevent exhaust gas from flowing directly from the inlet 105 to the outlet 112 without releasing heat to the carrier body 12 or to the medium located therein. Furthermore, in FIG. 7, three receptions 164 can be seen, which serve to receive screws of a screw connection 130. A jacket 106 or a cap 124 of a jacket may be attached to the carrier body 12 via these receptions 164. The carrier body shown in FIG. 7 is suitable for use in all arrangements described so far. It may be envisioned that guide fins are also arranged on the inner face of the cladding so as to generate, jointly with the guide fins 160 of the carrier body 12, the desired flow field.

The features of the invention described in the preceding description, the drawings, and the claims may be substantial both individually and in any combination for implementing the invention.

### LIST OF REFERENCE NUMERALS

10 Heat exchanger
12 Carrier body
14 Inner face
15 Outer face
16 Inner barrier
18 Outer barrier
20 Flow space
22 Carrier ring
24 Inlet for heat transfer medium
25 Outlet for heat transfer medium
26 Exhaust gas outlet
100 Heat exchanger
102 Outer exhaust gas duct
104 Exhaust gas pipe
105 Exhaust gas inlet

### 106 Jacket

108 Exhaust gas flow space

### 110 Fins

112 Exhaust gas outlet

### 114 Prolongation

### 120 Burner

122 Flame pipe

### 124 Cap

### 126 Coat

128 Clamp reception
130 Screw connection

### 132 Floor

134 Noise suppressing material
136 Aperture plate
138 Cap guiding fin
140 Tube connection
142 First tube shell
144 Second tube shell
146 First connection flange
147 First connection flange
148 Second connection flange
149 Second connection flange
150 First guide bar
152 Second guide bar

1. Heat exchanger for a mobile heating device having a burner, comprising
a carrier body having an inner face and an outer face, the inner face being formed as an inner exhaust gas duct for conducting exhaust gas of the burner, and
a channeling arranged between the inner face and the outer face of the carrier body and adapted to conduct a heat transfer medium,
wherein the heat transfer medium is in heat conducting contact via the inner face of the carrier body with the exhaust gas flowing in the inner exhaust gas duct,
wherein an outer exhaust gas duct for conducting exhaust gas of the burner is provided at the outer face of the carrier body, and
wherein the heat transfer medium is in heat conducting contact via the outer face of the carrier body with exhaust gas flowing in the outer exhaust gas duct.

2. The heat exchanger of claim 1, comprising an exhaust gas pipe connecting the inner exhaust gas duct and the outer exhaust gas duct.

3. The heat exchanger of claim 2, arranged such that exhaust gas flows through the inner exhaust gas duct before flowing through the outer exhaust gas duct.

4. The heat exchanger of claim 1, wherein a noise suppressor device is provided in the outer exhaust gas duct.

5. The heat exchanger of claim 4, wherein the noise suppressor device comprises a noise absorbing material.

6. The heat exchanger of claim 4, wherein the noise suppressor device is provided at a floor surface of the outer exhaust gas duct, particularly a floor of a cap of a jacket.

7. The exchanger of claim 1, wherein guide fins for guiding the exhaust gas are provided in the outer exhaust gas duct.

8. The heat exchanger of claim 2, wherein the exhaust gas pipe is formed as a tube connection extending at least partially outside the carrier body.

9. A mobile heating device having a burner and a heat exchanger as set forth in one of claim 1.

10. A motor vehicle comprising a mobile heating device as set forth in claim 9.
